(19) United States
(12) Patent Application Publication
(10) Pub. No.: US 2020/0206754 A1
(43) Pub. Date: Jul. 2, 2020

(54) SHOWERS

(71) Applicant: Purity (Xiamen) Sanitary Ware Co., Ltd., Xiamen City (CN)

(72) Inventors: JAMES WU, Taichung City (TW); ALEX WU, Taichung City (TW); CE-WEN YANG, Xiamen City (CN)

(73) Assignee: Purity (Xiamen) Sanitary Ware Co., Ltd., Xiamen City (CN)

(21) Appl. No.: 16/232,462

(22) Filed: Dec. 26, 2018

(51) Int. Cl. B05B 1/18; A47K 3/28; B05B 1/34

(52) U.S. Cl. CPC B05B 1/185; E03C 1/0404; B05B 1/3426; A47K 3/281

(57) ABSTRACT

A shower including a main body and a rotatable member. The main body includes a transparent front cap and a rear housing, wherein the transparent front cap and the rear housing are connected to each other, and an accommodating space is composed by the transparent front cap and the rear housing. The transparent front cap has a plurality of spray bores, and the rear housing has an inlet bore communicating with the spray bores through the accommodating space. A rotatable member is positioned in the accommodating space. The rotatable member could rotate relative to the main body while water flows through the accommodating space.

### BACKGROUND OF THE INVENTION

### 1. Technical Field

The present disclosure relates generally to showers, and more particularly to a shower having multiple rotatable fan blades.

### 2. Description of Related Art

Recently, many children do not like to take a shower because they think shower is boring, without fun activities; especially for some babies, they would be scared of showering because they cannot intently take a show owing to interference of environment factors.

However, there is still no efficient solution nowadays around children's shower problem. What is needed is a novel shower which could attract children and babies' attention when they are taking a shower.

At least for the above reasons, the conventional showers still have room for improvements.

### BRIEF SUMMARY OF THE INVENTION

In view of the above, the primary objective of the present disclosure is to provide a shower having a plurality of fan blades which could present a colorful pattern in order to attract children or babies' attention, and thereby they would love to take a shower while shower becomes an interesting thing to young children and babies.

The present disclosure provides a shower including a main body and a rotatable member. The main body includes a transparent front cap and a rear housing, wherein the transparent front cap and the rear housing are connected to each other, and an accommodating space is composed by the transparent front cap and the rear housing. The transparent front cap has a plurality of spray bores, and the rear housing has an inlet bore communicating with the spray bores through the accommodating space. A rotatable member is positioned in the accommodating space. The rotatable member could rotate relative to the main body while water flows through the accommodating space.

With the aforementioned design, the shower includes a plurality of fan blades which could rotate along with water flow, whereby to present a colorful pattern in order to attract children or babies' attention. Thereby, they would love to take a shower while shower becomes an interesting thing to young children and babies.

### BRIEF DESCRIPTION OF THE SEVERAL VIEWS OF THE DRAWINGS

The present disclosure will be best understood by referring to the following detailed description of some illustrative embodiments in conjunction with the accompanying drawings, in which

FIG. 1 is a perspective view of a shower of one embodiment of the present disclosure;

FIG. 2 is an exploded view of the shower of one embodiment of the present disclosure;

FIG. 3 is a cross-sectional view of the shower of one embodiment of the present disclosure;

FIG. 4 is a front cross-sectional view of a main body of the shower of one embodiment of the present disclosure;

FIG. 5 is a front view of a combination of the main body and a waterwheel of the shower of one embodiment of the present disclosure;

FIG. 6 is an exploded view of a fan blades and a friction ring of the shower of one embodiment of the present disclosure.

FIG. 7 is an exploded view of a transparent front cap and the friction ring of the shower of one embodiment of the present disclosure;

FIG. 8 is a rear view of a combination of the transparent front cap and the friction ring of the shower of one embodiment of the present disclosure; and

FIG. 9 is an exploded view of a rear housing and the friction ring of the shower of one embodiment of the present disclosure.

### DETAILED DESCRIPTION OF THE INVENTION

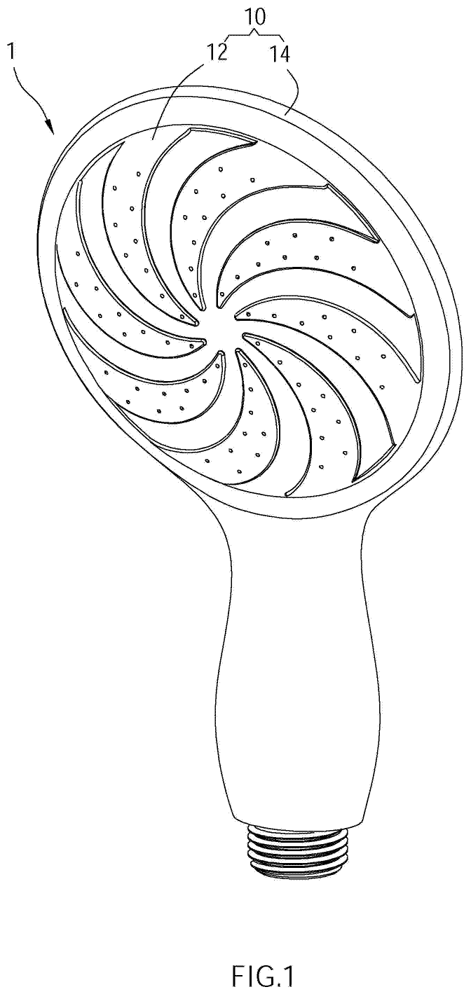

As illustrated in FIG. 1 to FIG. 8, a shower 1 is provided, including a main body 10 and a rotatable member 20. The main body 10 includes a transparent front cap 12, a rear housing 14, and a rotation shaft 11, wherein the transparent front cap 12 and the rear housing 14 are connected to each other, and an accommodating space 101 is composed by the transparent front cap 12 and the rear housing 14. The rotation shaft 11 is positioned in the accommodating space 101, and one end of the rotation shaft 11 contacts with the transparent front cap 12 while another end of the rotation shaft 11 contacts with rear housing 14.

The transparent front cap 12 has a plurality of spray bores 121, and the rear housing 14 has an inlet bore 141 communicating with the spray bores 121 through the accommodating space 101.

The rotatable member 20 is positioned in the accommodating space 101, and having an axial hole 221 and a fan 22 having a plurality of fan blades 223, wherein the fan blades 223 are arranged around the axial hole 221. The rotation shaft 11 passes through the axial hole 221, whereby the rotatable member 20 could rotate relative to the main body 10 while water flows through the accommodating space 101.

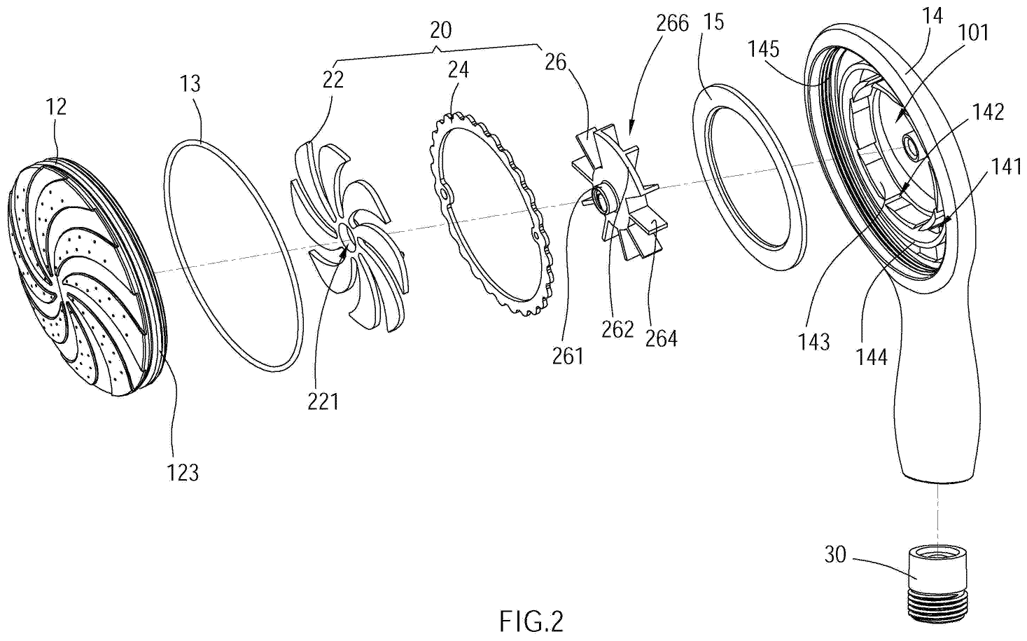

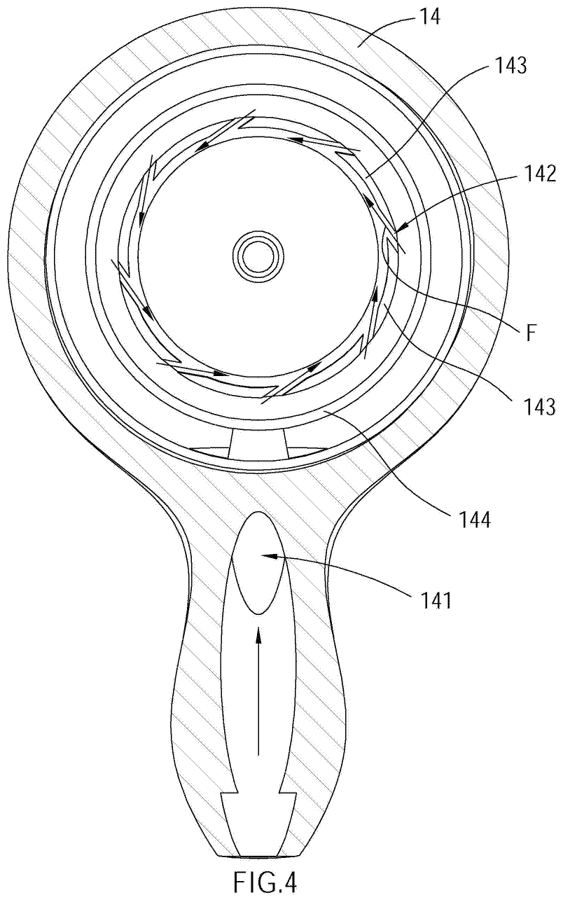

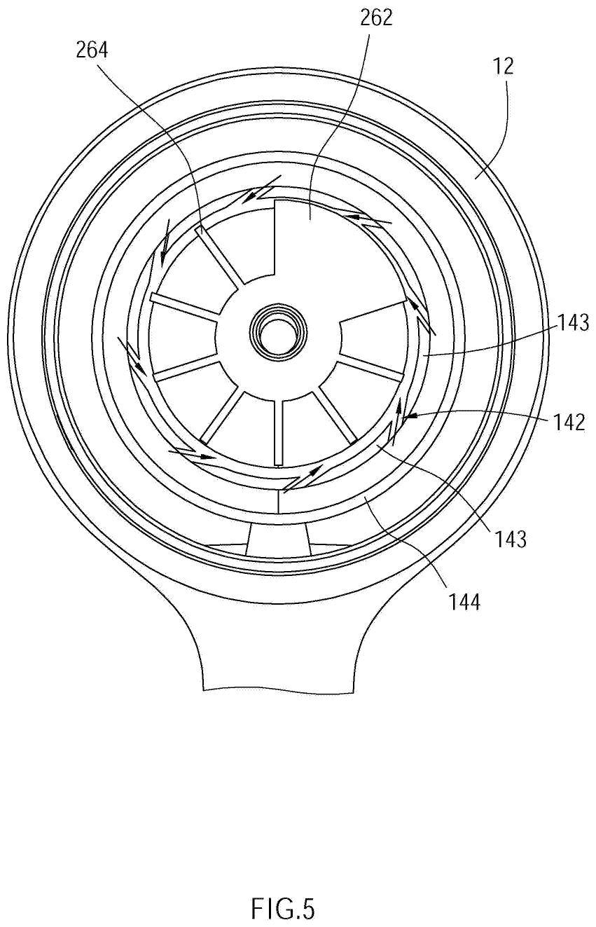

In FIG. 2, FIG. 4 and FIG. 5, the rear housing 14 includes a plurality of inner walls 143 and an outer wall 144. The inner walls 143 is positioned in the accommodating space 101. Furthermore, the inner walls 143 are arranged around the rotation shaft 11. It is worthy to note that, the rear housing 14 includes a plurality of inclined channels 142 positioned among the inner walls 143; in other words, each of the inclined channel 142 is positioned between adjacent two of the inner walls 143. When water F flows through the inclined channel 142, a vortex would be formed in the accommodating space 101. In addition, the outer wall 144 is positioned in the accommodating space 101 and positioned around the inner walls 143.

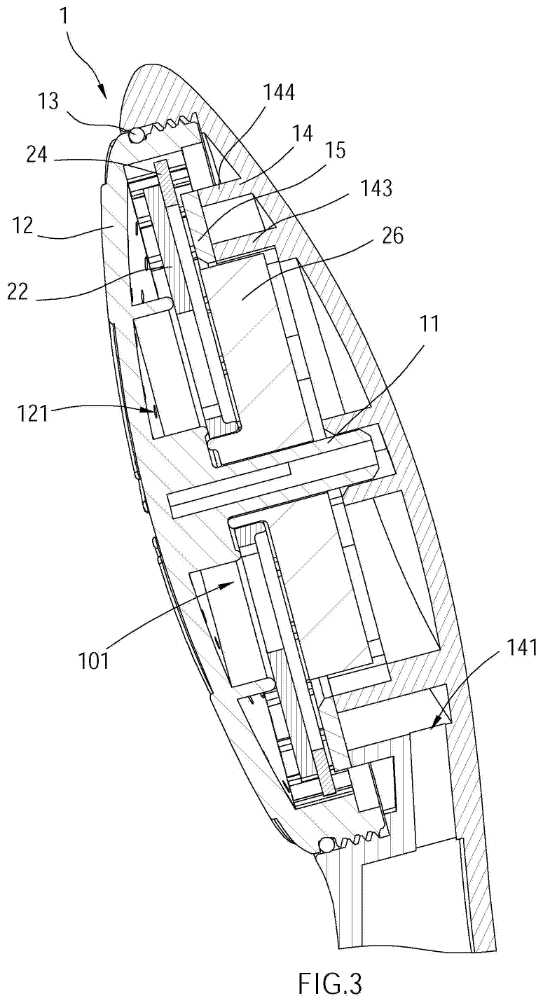

Furthermore, in FIG. 2 and FIG. 3, the main body 10 includes a circular pad 15 vertically connected to the inner walls 143 and the outer wall 144. In detail, the circular pad 15 has an inner edge fixedly connected to the inner walls 143, and an outer edge of the circular pad is fixedly connected to the outer wall 144.

Referring to FIG. 2 and FIG. 5, the rotatable member 20 includes a waterwheel 26 positioned in the accommodating space 101 and positioned behind the fan 22. In addition, the waterwheel 26 includes a plurality of vanes 264, whereby the vanes 264 would be pushed to rotate the waterwheel 26 when water flows into the accommodating space 101.

Besides, the waterwheel 26 includes a protruding shaft 261 passing into the axial hole 221, when the waterwheel 26 rotates, the waterwheel 26 drives the fan 22 to rotate. It is worthy to note that, the waterwheel 26 includes at least one block 262, which is vertically connected to at least one of the vanes 264, whereby to improve water pushing the waterwheel 26 to rotate. When water flows into a space composed by the vanes 264 and the block 262, the water would temporarily stay in the space, and would continuously push the waterwheel 26 to rotate.

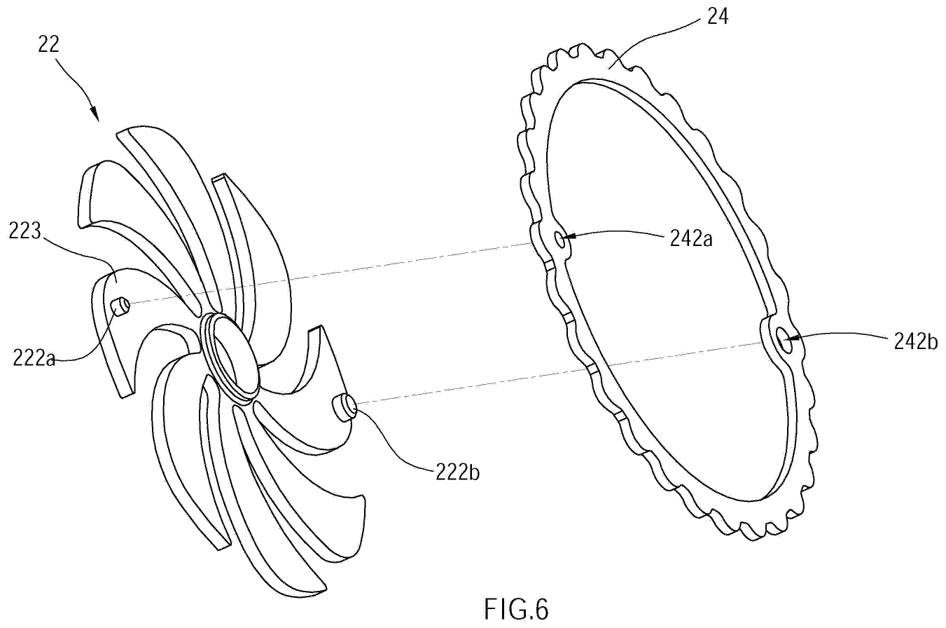

Referring to FIG. 2, FIG. 6 to FIG. 8, the rotatable member 20 includes a friction ring 24, and the friction ring 24 is connected to the fan 22. When the fan 22 rotates, the fan 22 drives the friction ring 24 to rotate synchronously, and the friction ring 24 and the transparent front cap 12 friction with each other.

In FIG. 6, the fan has a plurality of protruding blocks 222a, 222b. Each of the protruding blocks 222a, 222b is positioned on one of the fan blades 223, and the friction ring 24 has a plurality of through holes 242a, 242b. The protruding blocks 222a, 222b respectively pass into the through holes 242a, 242b; in other words, the protruding blocks 222a passes into the through holes 242a while the protruding blocks 222b passes into the through holes 242b. In one embodiment of the present disclosure, the size of the protruding blocks 222b is greater than that of the protruding blocks 222a, and the hole size of the through holes 242b is greater than that of the through holes 242a. In one embodiment of the present disclosure, the protruding blocks 222a, 222b are symmetrically positioned on a plane, while the through holes 242a, 242b are symmetrically positioned on another plane. In one embodiment of the present disclosure, the fan 22 is positioned between the friction ring 24 and the transparent front cap 12.

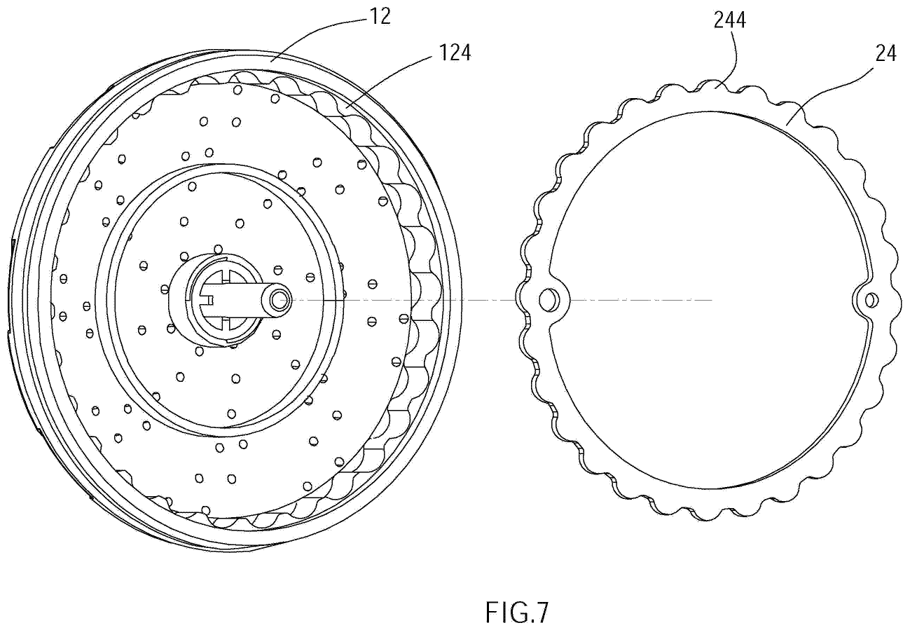

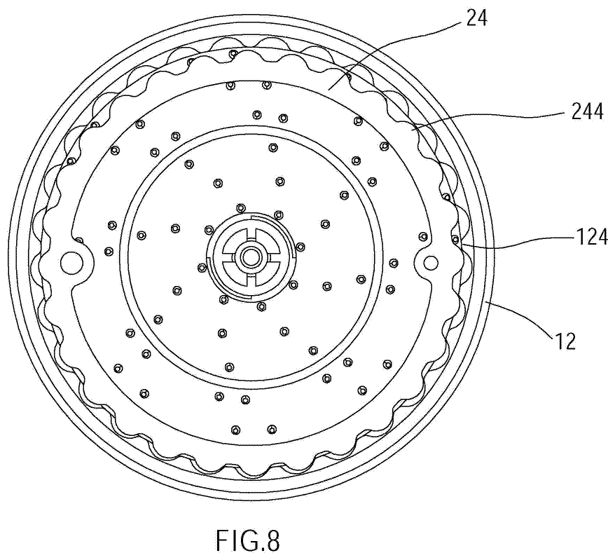

In FIG. 7 and FIG. 8, the friction ring 24 includes a plurality of first protrusions 244, and the transparent front cap 12 includes a plurality of second protrusions 124. When the friction ring 24 rotates, at least part of the first protrusions 244 of the friction ring 24 and at least part of the second protrusions 124 of the transparent front cap 12 contact with each other, and friction with each other in order to slow down a rotation rate of the fan 22. In one embodiment of the present disclosure, the first protrusions 244 are continuously arranged on an outer surface of the friction ring 24. In one embodiment of the present disclosure, the second protrusions 124 are continuously arranged on an inner surface of the transparent front cap 12.

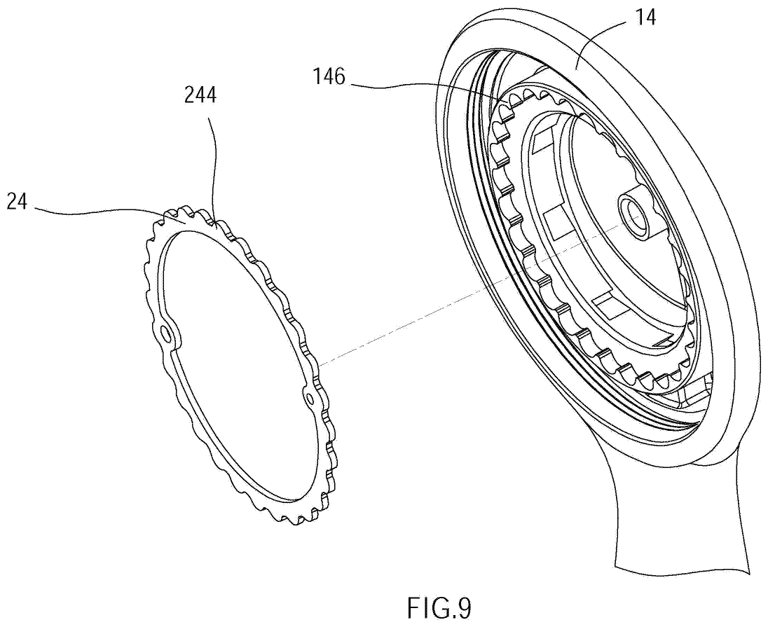

In FIG. 9, the friction ring 24 includes a plurality of first protrusions 244, and the rear housing 14 includes a plurality of second protrusions 146. When the friction ring 24 rotates, at least part of the first protrusions 244 of the friction ring 24 and at least part of the second protrusions 146 of the rear housing 14 contact with each other, and friction with each other in order to slow down a rotation rate of the fan 22. In one embodiment of the present disclosure, the first protrusions 244 are continuously arranged on an outer surface of the friction ring 24. In one embodiment of the present disclosure, the second protrusions 146 are continuously arranged on an inner surface of the rear housing 14.

In FIG. 2, the shower 1 includes a sealing ring 13 positioned between the transparent front cap 12 and the rear housing 14.

In one embodiment of the present disclosure, at least one part of the transparent front cap 12 has a first pattern while at least one part of the fan 22 of the rotatable member 20 has a second pattern. In one embodiment of the present disclosure, the first pattern is the same as the second pattern. In one embodiment of the present disclosure, the first pattern is different from the second pattern.

In one embodiment of the present disclosure, at least one part of the transparent front cap 12 has a first color while at least one part of the fan 22 of the rotatable member 20 has a second color. In one embodiment of the present disclosure, the first color is the same as the second color. In one embodiment of the present disclosure, the first color is different from the second color.

In FIG. 2, the transparent front cap 12 has a first screw thread 123 on an outer surface of the transparent front cap 12, and the rear housing 14 has a second screw thread 145 on an inner surface of the rear housing 14, whereby the transparent front cap 12 is screwed with the rear housing 14. The shower 1 includes an inlet connector 30 connected to the main body 10 and communicating with the inlet bore 141 of the main body 10.

With the aforementioned design, the shower includes the fan which could rotate along with water flow, whereby to present a colorful pattern in order to attract children or babies' attention. Thereby, they would love to take a shower while shower becomes an interesting thing to young children and babies.

It must be pointed out that the embodiments described above are only some preferred embodiments of the present disclosure. All equivalent structures which employ the concepts disclosed in this specification and the appended claims should fall within the scope of the present disclosure.

What is claimed is:

1. A shower, comprising:
a main body, comprising a transparent front cap and a rear housing, wherein the transparent front cap and the rear housing are connected to each other, and an accommodating space is composed by the transparent front cap and the rear housing; the transparent front cap has a plurality of spray bores, and the rear housing has an inlet bore communicating with the spray bores through the accommodating space; and
a rotatable member, positioned in the accommodating space, wherein the rotatable member could rotate relative to the main body while water flows through the accommodating space.

2. The shower of claim 1, wherein the rear housing comprises a rotation shaft and a plurality of inner walls positioned in the accommodating space, and the inner walls are arranged around the rotation shaft; one end of the rotation shaft contacts with the transparent front cap while another end of the rotation shaft contacts with rear housing; an inclined channel is positioned between adjacent two of the inner walls; when water flows through the inclined channel, a vortex would be formed in the accommodating space.

3. The shower of claim 2, wherein the rear housing comprises an outer wall positioned in the accommodating space and positioned around the inner walls.

4. The shower of claim 3, wherein the main body comprises a circular pad vertically connected to the inner walls and the outer wall.

5. The shower of claim 4, wherein the circular pad has an inner edge fixedly connected to the inner walls, and an outer edge of the circular pad is fixedly connected to the outer wall.

6. The shower of claim 2, wherein the rotatable member comprises an axial hole and a fan having a plurality of fan blades, wherein the fan blades are arranged around the axial hole.

7. The shower of claim 6, wherein the rotatable member comprises a waterwheel positioned in the accommodating space; the waterwheel comprises a plurality of vanes;
when water flows into the accommodating space, the vanes would be pushed to rotate the waterwheel.

8. The shower of claim 7, wherein the waterwheel comprises a protruding shaft passing into the axial hole, when the waterwheel rotates, the waterwheel drives the fan to rotate.

9. The shower of claim 8, wherein the waterwheel comprises at least one block, the block is vertically connected to at least one of the vanes.

10. The shower of claim 6, wherein the rotatable member comprises a friction ring connected to the fan, when the fan rotates, the fan drives the friction ring to rotate synchronously, and the friction ring and the transparent front cap friction with each other.

11. The shower of claim 10, wherein the fan has a plurality of protruding blocks, and the friction ring has a plurality of through holes; the protruding blocks respectively pass into the through holes.

12. The shower of claim 11, wherein the protruding blocks are symmetrically positioned on a plane, while the through holes are symmetrically positioned on another plane.

13. The shower of claim 10, wherein the fan is positioned between the friction ring and the transparent front cap.

14. The shower of claim 10, wherein the friction ring comprises a plurality of first protrusions, and the transparent front cap comprises a plurality of second protrusions;
when the friction ring rotates, at least part of the first protrusions of the friction ring and at least part of the second protrusions of the transparent front cap contact with each other, and friction with each other.

15. The shower of claim 14, wherein the first protrusions are continuously arranged on an outer surface of the friction ring.

16. The shower of claim 14, wherein the second protrusions are continuously arranged on an inner surface of the transparent front cap.

17. The shower of claim 10, wherein the friction ring comprises a plurality of first protrusions, and the rear housing comprises a plurality of second protrusions; when the friction ring rotates, at least part of the first protrusions of the friction ring and at least part of the second protrusions of the rear housing contact with each other, and friction with each other.

18. The shower of claim 1, further comprising a sealing ring positioned between the transparent front cap and the rear housing.

19. The shower of claim 1, wherein at least one part of the transparent front cap has a first pattern while at least one part of the fan of the rotatable member has a second pattern.

20. The shower of claim 1, wherein at least one part of the transparent front cap has a first color while at least one part of the fan of the rotatable member has a second color.
